(19) United States
(12) Patent Application Publication
(10) Pub. No.: US 2026/0259559 A1
(43) Pub. Date: Sep. 3, 2026

(54) HAPTIC FEEDBACK FOR TRAILER CONTROLLER AND/OR SWITCHES

(71) Applicant: HORIZON GLOBAL AMERICAS INC., Plymouth, MI (US)

(72) Inventors: Henry J. GUTHARD, Plymouth, MI (US); Jyeshta BELLUR, Plymouth, MI (US); Srikanth KADUDULA, Plymouth, MI (US)

(73) Assignee: HORIZON GLOBAL AMERICAS INC., Plymouth, MI (US)

(21) Appl. No.: 19/497,151

(22) PCT Filed: Dec. 20, 2023
(86) PCT No.: PCT/US2023/085136

§ 371 Date: Dec. 24, 2025

Related U.S. Application Data
(60) Provisional application No. 63/433,855, filed on Dec. 20, 2022.

(51) Int. Cl. G05D 1/224; B60W 10/18; B60W 50/16; G05D 1/223; G05D 109/10; G06F 3/01

(52) U.S. Cl. CPC G05D 1/2242; B60W 10/18; B60W 50/16; G05D 1/223; G06F 3/016; B60W 2300/14; G05D 2109/16

(57) ABSTRACT

A control system for controlling trailer-related functions and reporting trailer conditions to an operator of a towing vehicle is disclosed. The system includes a control device operable by the operator and communicatively coupled to a trailer to control at least one trailer-related function and to receive signals indicative of trailer operation or condition. A haptic feedback device is operably associated with the control device and is configured to provide tactile feedback in response to operator input or in response to signals received from the trailer. The haptic feedback may include different vibration patterns corresponding to confirmation of commanded operation, changes in a trailer-related function, or fault or warning conditions. In some implementations, an intensity or pattern of the haptic feedback varies based on a degree of operator input or a control signal associated with the trailer-related function. The system is particularly suited for trailer braking applications.

### CROSS REFERENCE TO RELATED APPLICATIONS

This application is the U.S. national phase entry under 35 U.S.C. § 371 of International Application No. PCT/US2023/085136, filed Dec. 20, 2023, entitled HAPTIC FEEDBACK FOR TRAILER CONTROLLER AND/OR SWITCHES, all of which is incorporated herein by reference in its entirety for all purposes.

### FIELD OF THE INVENTION

The present disclosure relates to controllers and switches for use in controlling and/or reporting the condition of braking functions, and other functions, related to trailers being towed by vehicles. More specifically, the present disclosure relates to apparatuses and methods for providing controllers or switches having haptic feedback so that an operator of a vehicle towing a trailer does not need to divert visual attention from operating the vehicle to control a trailer function and/or be made aware of conditions related to the trailer.

### BACKGROUND

Current controllers/switches used for operators of towing vehicles to control and/or report the status of functions, including braking, lights, etc., on towed trailers generally require the operator to divert eye contact from operating the vehicle to operate which is not optimal and can lead to accidents and/or injury if not done properly. Generally, the only responsive feedback that operators have received from prior art switches/controllers have been limited to visual (such as lights, gauges, etc.) and/or aural (in the form of beeps or other aural alarms) for providing information regarding the operation and status of towed-trailer functions. Examples of such prior-art systems include those disclosed in U.S. Pat. No. 9,738,125, the entirety of which is incorporated herein by reference. Accordingly, it would be desirable to have switches and/or controllers for a vehicle operator to use in controlling functions and/or providing the status of various operations related to a towed a trailer that provide feedback to the driver related thereto that does not require the driver to lose visual contact with the road/driving surface.

### SUMMARY

Haptic technologies make use of actuators (or other apparatuses) to apply forces or provide other feedback to an operator who is touching the device/switch having the haptic technology incorporated therein. Such haptic technologies can include actuators that create some type of mechanical motion that is transmitted to a surface and/or switch that the operator is touching. Early haptic actuators made use of electromagnetic technology such as vibratory motors which provided a somewhat limited number of feedback sensations. Newer forms of this technology have resulted in more sophisticated devices that can be used to provide specific responses or that are fully customizable by the operator as desired. Even newer haptic technologies have provided devices that are sensitive to the pressure provided by the operator and which can provide proportional responses to the amount of force applied by the operator.

The present disclosure provides methods and apparatuses for adding haptic technology which provide a positive response, such as a vibration, to switches and/or controllers used in trailer-towing applications. Specific applications of such methods and apparatuses can include haptic actuators that provide indications to vehicle operators of a given function change and/or status through a pattern of vibrations when a switch (such as a manual slider or other switch/auxiliary controller) is actuated by the operator pressing, pulling, rotating a switch or button and/or touching a touchscreen. Other non-limiting operator indications may include a pattern of vibrations for warnings indicating or any faults for things trailer breakaway, no connection (NC), short to ground (STG), short to battery (STB).

The advantage of using haptic feedback in accordance with the present invention as disclosed herein is that the operator need not divert his vision to look at the auxiliary controller/switch/instrument cluster to see the exact condition or warning that is being transmitted from the trailer to the operator. Instead, the intensity and/or pattern of haptic feedback provides the operator the indication of that condition/warning. Other uses of haptic technology in accordance with the present disclosure include, but are not limited to, warnings of any faults observed and/or hazardous conditions provided as feedback from any of the trailer towing systems and/or accessories as well as current status of conditions of various trailer systems and functions. Finally, information can also be provided to the operator in accordance with the present disclosure through the lack of haptic feedback where the operator would otherwise expect a haptic response.

### BRIEF DESCRIPTION OF THE DRAWINGS

Illustrative detailed embodiments of the invention will hereinafter be described in conjunction with the appended drawings provided to illustrate, but not limit the invention, where like designations denote like elements and in which:

FIG. 1 is an exploded view of an auxiliary controller operable for use in connection with a haptic feedback apparatus in accordance with aspects of the present disclosure;

FIG. 2 is a partial schematic representation of exemplary switches/controllers operative in connection with a haptic feedback apparatus of the present disclosure;

FIG. 3 is a block flow diagram illustrating a control loop for use in connection with an exemplary embodiment of a slide switch having a haptic feedback apparatus incorporated therein in accordance with aspects of the present disclosure; and

FIG. 4 is a chart representing the duty cycle for a haptic feedback apparatus as used in an on/off, linear and exponential control arrangement in accordance with the disclosure.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

The present invention provides a haptic feedback apparatus that provides a positive physical response, such as a vibration, to switches and/or controllers used in trailer-towing applications. Specifically, the present invention provides haptic feedback apparatuses that provide indications to vehicle operators of a given function change and/or status through a pattern of vibrations when a switch (such as a manual slider or other switch/controller) is actuated by, for example, the operator pressing, pulling, rotating or touching a touchscreen.

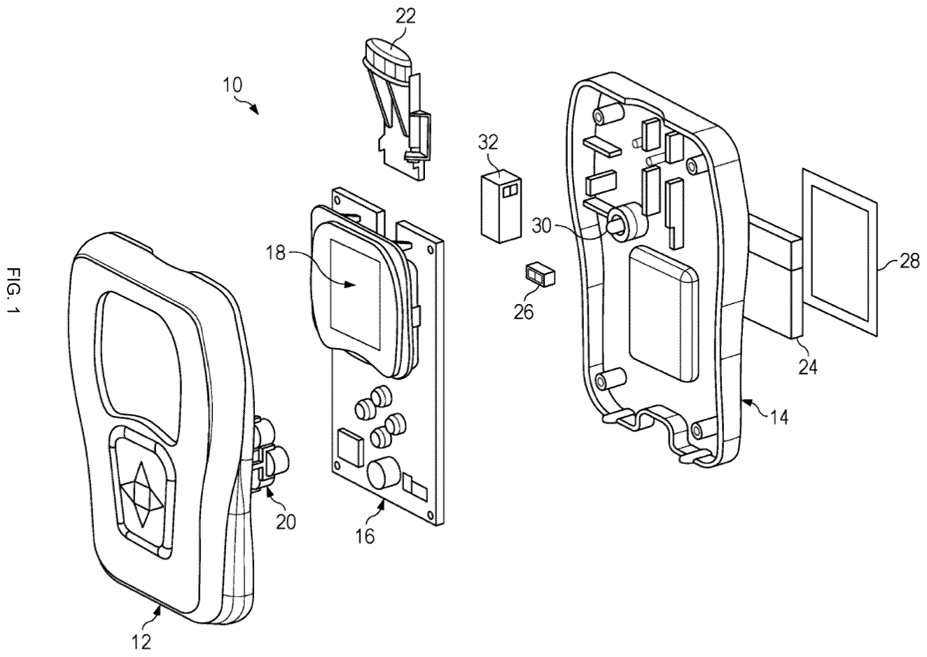

As best shown in FIG. 1, in accordance with aspects of the invention, an auxiliary controller 10 may be utilized in vehicle trailer towing applications which sends control signals, such as braking and/or lighting controls (or other functions), to the corresponding control circuits of the trailer and receives response signals back. More specifically, as is known in the art, the auxiliary controller 10 may include a front housing 12, back housing 14 for encasing a control board 16 having an LED indicator 18 thereon. It may be provided with control buttons 20 and a manual override button 22 to provide operator control. Power may be supplied by a battery 24 which is connected to the control board 16 by a connector 26 and which is held in the housing by a battery cover 28. Operator output devices including a buzzer 30 and a haptic feedback actuator 32 may be mounted in the case to provide operator feedback and connected to the control board as is known in the art. The haptic feedback actuator 32 in accordance with the invention is connected to the control circuits of the control board 16 and mounted to inside the controller 10 to provide a desire haptic output when the operator sends a desired output (such as braking at a predetermined force) to the trailer brakes. When used in this way, it is generally desired that current output from the power source, such as the battery 24, and as controlled by the controller 10, should match and/or be proportional to the haptic feel desired.

Examples of haptic feedback apparatuses that would be useful in connection with the present invention include, but are not limited to, eccentric rotating mass motors (ERMs) linear resonant actuators (LRAs), and Piezo-electric actuators. ERMs are generally comprised of a DC motor with an offset (non-symmetric) mass attached to the shaft. A constant voltage drives the motor at a constant speed, and hence constant frequency and vibration amplitude, until the power supply is switched off. Downsides to ERMs is that and additional “start up” current is required, take more power than other options, and require additional braking.

LRAs provide haptic feedback through linear motion. The vibrations created by an LRAs are based upon the movement of a mass which causes repeated displacement with spring and magnetic coil and provide maximum vibration at a resonant frequency of the LRA and a much lower vibration at non-resonant frequencies. Built with an internal magnetic mass and spring, an electrical current in voice coil causes the mass to displace. In order to drive the mass in the opposite direction, the current in the voice coil must be reversed, so LRAs are driven by AC signals. Also, given that the mass moves in a straight line, vibrations are only produced on one axis. LRAs have some advantages over ERMs. LRAs vibrate at a fixed resonant frequency which means that varying the amplitude of vibration doesn't affect the vibration frequency (which does occur in ERM motors). With no internal brushes or commutators, LRAs have a longer life, have improved haptic response times, and use less power than ERMs. Also, a multitude of different feedbacks can be achieved by varying the AC drive signal in LRAs because small changes in Hertz significantly affects the output amplitude. Conversely, LRAs can be somewhat more expensive than ERMS in that they require an additional driver circuit to operate.

Piezo-electric haptic actuators utilize the piezo effect to generate vibrations using piezoelectric material mounted in a cantilever beam configuration inside the actuator. Unlike ERMs and LRAs, the amplitude and frequency of the deflection can be controlled individually, allowing for considerably more sophisticated and detailed signal waveforms. A voltage signal across the piezoelectric materials causes the material in the beam to bend, the bend dependent on the two different types of materials used therein to create displacement near the tip of the beam. Advantages of Piezo-electric actuators include the possibility for very quick and precise vibration patterns, higher resonance frequencies, multiple vibration patterns, low power consumption, and smaller sizes.

In accordance with the present disclosure, ERMs, LRAs, Piezo electric, as well as other types of haptic feedback devices and/or actuators, may be used in accordance with aspects of the present invention. Further, in addition to providing operator feedback during actuation of a controller and/or switch as to confirmation of the requested operation (applying brakes for the towed vehicle), or magnitude of the requested operation (amount of braking force requesting being applied), the haptic feedback apparatuses in accordance with the present invention may provide status information and/or warnings or alerts. In accordance with aspects of the invention, embedded software may preferably determine the duty cycle of a pulse width modulation cycle driving the vibration based on actual braking applied at the output of the braking module. As braking duty cycle increases, vibration intensifies to give a feel to operators.

With respect to status confirmation, such status confirmation may include confirmation that requested braking is applied at the 7-way brake output through confirmation feedback received from the trailer brake magnets. Other operator indications include a pattern of vibrations when gain and/or boost is varied to certain different extents for the trailer braking system or when other desired or undesired conditions are detected. Warnings that could be indicated via the haptic response could include warnings or any faults for things like breakaway, NC, STG, STB, or no etc.

As discussed above, the advantage of using haptic feedback in any of the above situations is that the operator need not divert his vision to look at the instrument cluster to understand what is going on with the towed trailer. Instead, the intensity and/or pattern of haptic feedback provides the operator an idea and feel of the particular status/request or warning, such as the amount of braking that is being applied. Other uses of haptic actuators in accordance with the present disclosure include warnings of any faults observed and/or hazardous conditions provided as feedback from any of the trailer towing systems and/or accessories. Similarly, current status of conditions of various trailer systems and functions are provided by the invention as well.

Other examples of uses of haptic actuators in accordance with the invention include providing information to the operator through the lack of haptic feedback. For example, the controller 10 could include programming disabling all haptic feedback when there is no trailer connected so the operator would know, through the lack of haptic feel, that the trailer is not connected. For example, if the operator applies braking, or any other action, through the controller 10 (or other device, such as a slider switch) in accordance with the invention, the operator would know that the trailer is disengaged through the lack of a haptic response.

Additionally, the haptic actuator 32 can provide a haptic output that is selected to inform the operator of various response signals received back. Non-limiting examples of such response signals can be signals received from 7-way door sensors, camera inputs, proximity sensors, mechanical coupling sensors, load sensors, breakaway switches, etc. and haptic feel, frequency, strength, etc. may be changed or altered depending on function or status being provided. A haptic actuator 32 as used in this way may be used as part of the operator decision-making process and feedback (e.g., ready to tow or not ready to tow) or to cause an action.

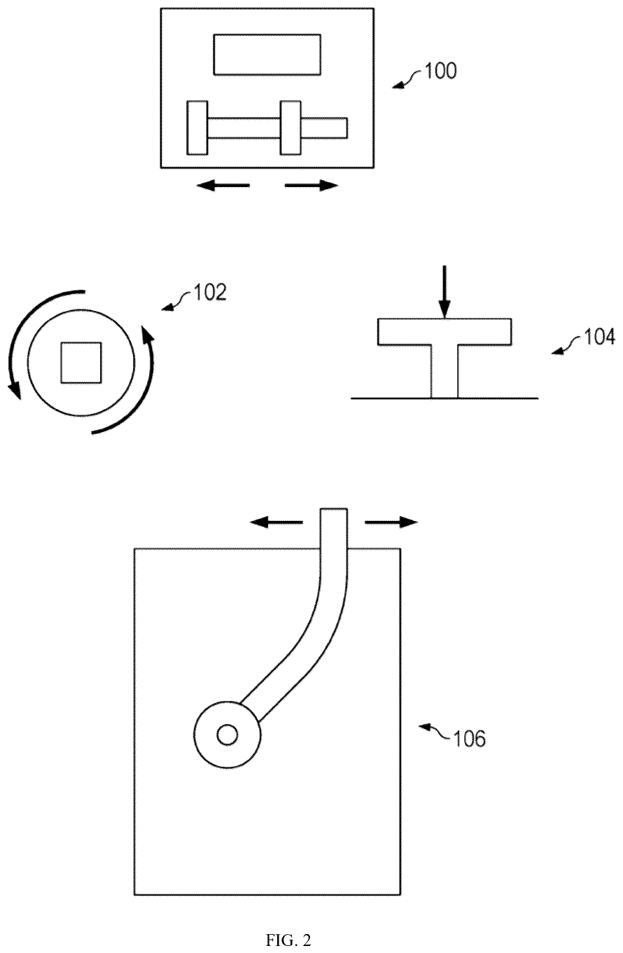

In another aspect of the present invention, as shown best in FIG. 2, a haptic actuator may be used in connection with other forms of switches and/or controllers in accordance with the invention. Non-limiting examples include manual slider switches 100, rotational knob switches 102, plunger switches 104 and lever switches 106 as are known in the art for use in controlling functions, such as braking, in a trailer being towed by a vehicle. Non-limiting examples of indications that can be provided via the haptic actuator mounted to the slider switch include: (1) indicate to the operator when manual slider is pressed to request braking; (2) indicate to the operator when the actual braking is applied; and (3) indicate warnings or any faults observed by the controller and/or slider module.

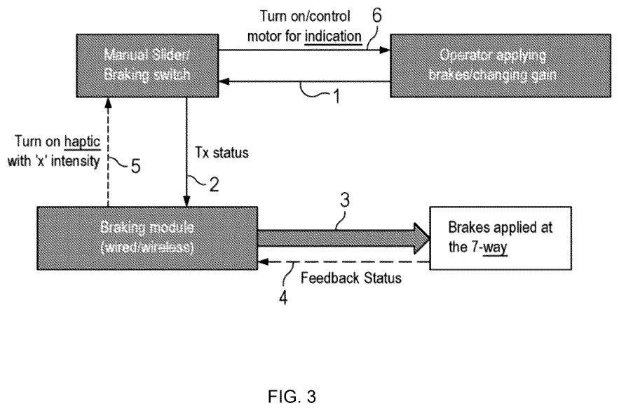

As with the controller 10 embodiment shown in FIG. 1, a slider embodiment preferably includes the haptic actuator being closely placed/attached to the manual slider to have the effect noticeable to operators. As best shown in FIG. 3, a control loop for use in connection with an exemplary embodiment of a slide switch having a haptic actuator incorporated therewith comprises the following steps: (1) operator squeezes manual slider; (2) manual slider notifies braking module about the status; (3) braking module pushes the braking duty cycle via output; (4) braking module feedback circuit checks the duty cycle; (5) based on duty cycle/feedback, braking module transmits manual slider to turn on haptic; (6) operator feels the vibration. As would be apparent to one of ordinary skill in the art, while the control loop shown in FIG. 3 applies to the use of a haptic actuator 32 as used in connection with a manual slider, it applies identically to use in an auxiliary controller 10 as shown in FIG. 1.

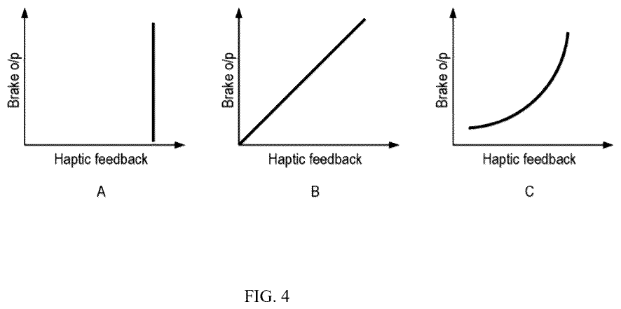

As depicted in FIG. 4, an exemplary duty cycle for a haptic feedback apparatus, whether used in an auxiliary controller 10 or manual slider application, may be of any known duty cycles for similar sized and shaped motors/actuators but specifically may include: on/off (A); linear (B); and exponential (C).

As discussed above, use of haptic actuators in accordance with the invention provide additional safety for operators since the operator need not have to look at any other indicators or move his focus away from roads which might be a potential hazard. When the brakes fail to be applied by the braking module, the operator will know immediately can take necessary precautions to avoid any accidents. When a fault is being recognized by the module, can indicate to operators if other indicators go unnoticed.

Having described exemplary embodiments of haptic apparatuses and methods for use with towed vehicle controllers and switches, it is noted that modifications and variations can be made by persons skilled in the art in light of the above teachings. It is therefore to be understood that changes may be made in exemplary embodiments of the invention, which are within the scope and spirit of the invention as defined by the appended claims. Having thus described the invention with the details and particularity required by the patent laws, what is claimed and protected is set forth in the appended claims.

What is claimed is:

1. A control system for controlling the functions and reporting the conditions of a trailer being towed by a vehicle, the control system comprising:
a control device for operation by an operator of the vehicle towing the trailer, the control device being operably connected to the trailer such to: control a trailer-related function; and receive a first signal related to the trailer-related function; and
a haptic feedback device operably connected to the control device such that: operation of the control device by an operator to control the trailer-related function results in activation of the haptic feedback device; and the receipt of the first signal from a trailer sensor results in activation of the haptic feedback device.

2. The control system of claim 1 wherein the haptic feedback device is selected from the group consisting of eccentric rotating mass actuators, linear resonant actuators, and Piezoelectric actuators, and wherein the trailer-related function controlled by the controller is a trailer braking system.

3-4. (canceled)

5. The control system of claim 2 wherein the haptic feedback device provides a pattern of vibration upon receiving a signal from said trailer braking system confirming that requested braking is being applied and wherein the signal received from said trailer braking system is generated from trailer brake magnets or trailer braking gain and/or boost levels.

6. (canceled)

7. The control system of claim 1 wherein the haptic feedback device provides: a first pattern of vibration upon activation by the first signal; and a second pattern of vibration upon receiving a second signal the second pattern being different from the first pattern.

8. The control system of claim 7 wherein the fault or warning condition is selected from the group consisting of trailer breakaway, no connection, short to ground, or short to battery.

9-20. (canceled)

21. The control system of claim 7 wherein at least one of the first and second patterns is customizable by the operator.

22. The control system of claim 7 wherein:
the second pattern relates to a change in trailer related function, the change corresponding to a condition selected from the group consisting of: a fault; a warning condition; and
combinations thereof; and
the second pattern includes a lack of the activation.

23. The control system of claim 1 wherein the control device includes means for varying degrees of activation of the haptic feedback device.

24. The control system of claim 23 wherein the means for varying degrees of activation is selected from the group consisting of a slider switch, a rotational knob switch, a plunger switch, a lever switch, and combinations thereof attached to the haptic feedback device.

25. The control system of claim 23 wherein as a degree of activation increases, vibration of the haptic feedback device increases in intensity.

26. The control system of claim 1 wherein an intensity of the activation of the haptic feedback device is proportional to a force applied by the operator during operation.

27. The control system of claim 26 wherein the intensity of the activation of the haptic feedback device increases exponentially.

28. The control system of claim 1 wherein an intensity of the activation of the haptic feedback device is proportional to an increasing duty cycle of a component adjusting the trailer-related function.

29. A system for reporting conditions of a trailer being towed by a vehicle, the system comprising:
a control device configured to adjust a trailer-related function; and
a haptic feedback device operably coupled to the control device for conveying information relating to the trailer-related function to an operator,
wherein an intensity of activation of the haptic feedback device increases as adjustment of the control device increases.

30. The system of claim 29 wherein the control device is further configured to generate a preset vibration pattern to signal predetermined events.

31. The system of claim 30 wherein the preset vibration patterns indicate an operating condition selected from the group consisting of: operation of trailer brakes, nonoperation of trailer brakes, confirmation that a requested braking level is being applied, and a fault condition associated with the trailer braking system.

32. The system of claim 31 wherein the vibration intensity and the preset vibration pattern are provided simultaneously to convey both a requested level of the trailer-related function and a condition of the trailer-related function.

33. A system for controlling a trailer related function and reporting conditions of a trailer being towed by a vehicle to an operator, the system comprising:
a control device operably coupled to an actuator to control the trailer-related function; and
a haptic feedback device operably coupled to the control device,
wherein the haptic feedback device is activated in response to a signal generated by a sensor for the trailer-related function to convey a condition of the trailer-related function to the operator.

34. The system of claim 33 wherein an intensity of the signal received by the control device corresponds to an intensity of activation of the haptic feedback device.

35. The system of claim 34 wherein the signal generated by the trailer-related function comprises a duty-cycle-modulated signal.
